(19) United States
(12) Patent Application Publication
(10) Pub. No.: US 2010/0323339 A1
(43) Pub. Date: Dec. 23, 2010

(54) Hemodynamic Simulator

(76) Inventor: James V. Ritchie, Chesapeake, VA (US)

Correspondence Address: FSB FisherBroyles, a Limited Liability Partnership, The Pinnacle Building, 3455 Peachtree Road, NE Fifth Floor, Atlanta, GA, 30326, US

(21) Appl. No.: 12/476,100

(22) Filed: Jun. 1, 2009

Related U.S. Application Data
(60) Provisional application No. 61/057,739, filed on May 30, 2008.

(51) Int. Cl. G09B 23/32

(52) U.S. Cl. 434/268

(57) ABSTRACT

The present invention comprises a hemodynamic simulator comprising four manual pumps to simulate the chambers of the heart, at least three valves to simulate valves in the circulatory system, an expandable container to simulate lung venous capacity, an expandable container to simulate arterial distensibility, a series of tubes to simulate peripheral resistance, a pressure gauge to simulate the monitoring of blood pressure; and a reservoir to store fluid to be pumped through the simulator.

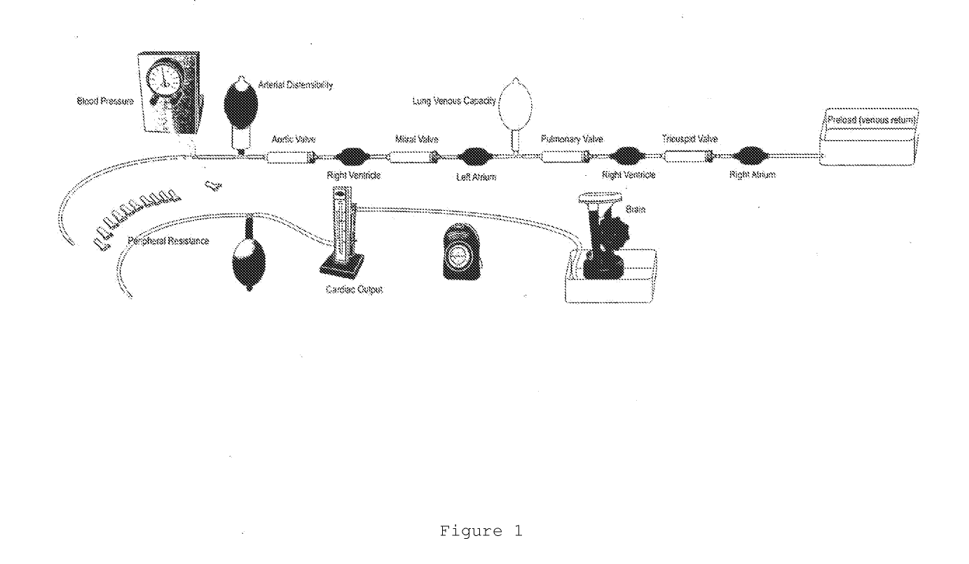

### CLAIM OF PRIORITY

This application claims priority from provisional application 61/057,739, “Hemodynamic Simulator Contraption” filed May 30, 2008.

### BACKGROUND OF THE INVENTION

1. Brief Description of Invention

The present invention is a hemodynamic simulator assembled from readily available, inexpensive components. It can be used to demonstrate complex, clinically pertinent physiologic concepts in a hands-on experiential setting.

2. Differences from Prior Art

Unlike previous devices, the present invention includes all four cardiac chambers and all four valves, representing both sides of the heart. Older devices include only one real pumping chamber and a collection chamber that does not pump, representing only one side of the heart. Also, older devices have simple valves that cannot be modified. The present invention includes valves that can be modified by making them stenotic or incompetent. Furthermore, the present invention includes a measurement of blood flow to the brain, entirely lacking in other devices. The present invention includes pulmonary blood capacity, which is crucial in teaching a variety of situations including left heart failure, pulmonary embolus, malignant hypertension, and others. Furthermore, the present invention also includes a means to simulate aortic distensibility and maintain blood pressure within a reasonable range between ventricular contractions. One older model uses a leg muscle pump to return blood to the heart, which is unnecessary for the present invention.

The present invention also far more accurately represents the functionality of the circulatory system. The blood flows in a true circulation. The idea of peripheral resistance is much more clearly demonstrated in the present invention, with multiple vessels available for clamping either partially or completely, compared to one simple clamp in the older device, whose resistance is virtually impossible to measure visually. Further, the present invention's peripheral resistance section is more precisely set before demonstrations and less dependent on trial and error. The cardiac output measurement on the older device is based on measurement in a syringe and multiplication with heart rate. The cardiac output device of the present invention is a flow meter, which instantly provides the number. The blood pressure measurement in the old device is via a simple open manometer which is very problematic in hypertensive situations and can allow air to enter the circuit. The blood pressure measurement of the present invention is via a closed meter, providing instant readings. Cardiac contractions in the old system are produced via pushing and pulling a syringe plunger repeatedly. In my device, contractions are direct, via squeezing a siphon bulb. This is far less tiring and more intuitive regarding effort of the heart.

### SUMMARY OF THE INVENTION

Briefly described, the present invention comprises a hemodynamic simulator that permits the instructor to replicate a range of conditions within the human body.

Thus, it is an object of the present invention to provide a hemodynamic simulator that is inexpensive and easy to build.

A further object of the present invention is to provide a device for instruction on the mechanics of cardiac and systemic vascular function that requires student interaction and problem-solving skills rather than memorization.

A further object of the present invention is to permit student participants to reproduce cardiac and systemic vascular function in a coordinated simulation.

Other objects, features, and advantages of the present invention will become apparent upon reading the following specification when taken in conjunction with the accompanying drawing.

### DETAILED DESCRIPTION OF A PREFERRED EMBODIMENT

As shown in the accompanying drawing, in a preferred embodiment, a hemodynamic simulator is comprised of clear plastic tubing, squeeze bulbs, Heimlich valves, simple plastic and metal connectors, balloons, IV tubing, plastic storage containers, a low-pressure gauge, a flow meter, and a child's water wheel.

A nine-quart clear plastic container 100 serves as the fluid reservoir. Two plastic elbow ⅜″ barb×⅜″ MIP hose barb adaptors 110 inserted low in the side of the container allow connection to tubes bringing water in and out. One fitting is attached to a clear plastic flexible tube ½″ inner diameter ⅝″ outer diameter (hereafter referred to as conduction tubing) 120 approximately two feet long. This tubing represents the vena cava, bringing blood to the heart.

### Right Side of the Heart

The following apparatus represents the right side of the heart: The vena cava tubing 120 is attached to a siphon squeeze bulb 200 by a double-sided ⅜″ barb splicer connector (hence called a splicer) 130, and the opposite side of the squeeze bulb is attached to a 3″ section of conduction tubing 210 by a splicer 220. This tubing attaches to the intake side of a Bard-Parker Heimlich Chest Drain Valve (hereafter called a Heimlich valve) 300, and the output side of the Heimlich valve is attached to another 3″ conduction tubing 310. This tubing is attached to a siphon squeeze bulb 400 by a splicer 320 and the opposite side of the squeeze bulb is attached to a 3″ section of conduction tubing 410 by a double-sided connector 420. This tubing attaches to a Heimlich valve intake 500, and the output side of the Heimlich valve is attached to another 3″ conduction tubing 510.

### Lung Blood Capacity

This section represents lung blood capacity. The tubing 510 is connected to a ¾×½×½ Tee-connector 520, with another 3″ section of tubing 530 directly opposite. The perpendicular ¾″ connection is attached to a thick-walled balloon 550. This balloon represents the Lung Venous Capacity. When the balloon is decompressed, the lungs are not overloaded with fluid. When the balloon is distended, the lungs are overfull with fluid.

### Left Side of the Heart.

This section represents the left side of the heart. The open section of tubing 530 is attached to another bulb-Heimlich-bulb-Heimlich sequence as described above.

The final 3″ section of tubing mentioned above connects to a ¾×½×½ Tee connector, with another section of tubing opposite. The perpendicular ¾″ fitting is attached to a complex of three thick-walled balloons inserted inside each other to produce one very thick-walled balloon 600. The balloons are inserted inside a 2″ PVC pipe section 610. This section simulates aortic distensibility or capacitance.

The final 3″ section of tubing mentioned above connects to a ½×½×¼ Tee connector 700. The perpendicular attachment is connected via a 6-inch section of ⅜″ OD ¼″ ID latex tubing to a ⅜″×¼ MIP adaptor 710. This open fitting is attached to a pressure gauge 720 measuring inches of water pressure. This represents blood pressure.

The open connector above is attached to the peripheral resistance assembly 800 via a section of conduction tubing 810. The peripheral resistance assembly consists of two three-foot sections of conduction tubing 810, 820 placed parallel and approximately one foot apart. Fifteen small holes 830 are drilled into each tube, approximately one inch apart, and on the same side of the tubing. A four-foot-long section of clear IV tubing 840 such as Alaris 4200 is inserted in the hole in one side and the corresponding hole in the parallel section of tubing and secured in place, producing a conduit for fluid to pass from the “arterial” tube to the “venous” tube. 14 other four-foot-long sections are glued in place in similar fashion, producing 15 separate conduits. Each IV tubing passes through a variable-flow thumb-wheel clamp 850 and a separate plastic clamp 860 to allow adjustment of flow, simulating increasing peripheral resistance. The tubing is coiled and secured without crimping it, to prevent tangles. The other end of the “arterial” tubing is occluded. The parallel side of the “venous” tubing is also occluded.

The open side of the “venous” tubing attaches to a ½×½×¾ Tee connector 900. The opposite-flow ¾″ connector is attached to a thick-walled balloon 910, which acts as a “surge capacitor” to even out the flow to the flowmeter, preventing surges which confuse measurements from the flow meter. There is no human physiologic counterpart; this section is unique to the model to allow more useful function.

The open connector is attached to conduction tubing 920, which enters the lower ⅜ barb×¼″ connector 930 inserted into a flowmeter 940. The upper ⅜″ barb×¼′ connector 950 is attached to a 2-foot section of conduction tubing 960, which is attached to the open plastic elbow ⅜″ barb×⅜″ MIP hose barb adaptor 970 in the 9-quart clear plastic container 100 noted at the beginning of this description. The flowmeter is used to measure cardiac output. This completes the circulatory flow.

A 16^{th} hole 835 is drilled in the “arterial” tubing of the peripheral resistance assembly, and one end of a 4-foot section of IV tubing 837 is glued into it. The open end is taped to the top of a child's water wheel assembly 1000. The water wheel is placed in the clear plastic container, and elevated approximately six inches on any object placed in the container. When “arterial” pressure reaches an appropriate level, water flows through this “carotid artery” and spins the water wheel, simulating brain function.

### Method of Use

About two gallons of water are poured in the clear plastic container, and pumped throughout the apparatus via the squeeze bulbs, taking care to remove all air from all parts. The apparatus is then ready for use.

After a short introduction, student participants reproduce cardiac and systemic vascular function in a coordinated simulation. Normal functional physiology is demonstrated, followed by scripted changes in physiologic conditions. At least four students are simultaneously involved in managing the simulation, including squeezing the bulbs in simulating heart chamber contraction, modifying afterload, preload, and heart rate, and assessing output parameters such as blood pressure, cerebral blood flow, and cardiac output. Using this model, the instructor is able to demonstrate and teach the following concepts using the present invention: preload, afterload, hypertensive consequences, effects of dysrhythmias, valve disorders, preload criticality with disorders such as tamponade and right ventricular MI, gradual nature of change in physiology, normal compensation despite serious malfunction, relationship of blood pressure with cardiac output, shock state despite normal BP, neurogenic shock, septic shock, hypovolemic shock, cardiogenic shock, cardiac work, maximum blood pressure, vasopressor physiology, diastolic dysfunction coupled with decreased preload or atrial dysfunction, and CHF treatment options. Trainees at all levels of training, including EMTs and senior physician residents, have grasped complex hemodynamic physiology concepts intuitively after participating with this hemodynamic simulator.

Water simulates blood in this construction. Squeeze bulbs are heart chambers, flutter valves are heart valves, balloons serve as capacitance vessels, plastic tubing serves as arteries and veins. The water wheel suggests brain activity. The pressure gauge measures blood pressure. The flowmeter measures cardiac output. A metronome 1100 sets the heart rate.

What is claimed is:

1. A hemodynamic simulator comprising
Four pumps to simulate the chambers of the heart;
At least three valves to simulate valves in the circulatory system;
An elastic container to simulate lung venous capacity;
An elastic container to simulate arterial distensibility;
A series of tubes to simulate peripheral resistance;
A pressure gauge to simulate the monitoring of blood pressure; and
A reservoir to store and receive fluid to be pumped through the simulator.

2. The hemodynamic simulator of claim 1, in which the elastic container to simulate arterial distensibility is comprised of at least two balloons, one inside the other, and a rigid container enclosing at least a portion of said balloons.

3. The hemodynamic simulator of claim 1, further comprising a separate tube to simulate the carotid artery.

4. The hemodynamic simulator of claim 3, in which the separate tube feeds fluid into an indicator of brain function.

5. The hemodynamic simulator of claim 4, in which the indicator of brain function is a water wheel.

6. The hemodynamic simulator of claim 1, further comprising a surge capacitor to moderate the flow of fluid through the simulator.

7. The hemodynamic simulator of claim 6, in which the surge capacitor is an elastic container.

8. The hemodynamic simulator of claim 1, further comprising a flow meter to measure fluid throughput, simulating a measure of cardiac output.

9. The hemodynamic simulator of claim 1, further comprising a metronome to set the heart rate to be applied by a user.

10. The hemodynamic simulator of claim 1, further comprising at least one clamp in each tube used to simulate peripheral resistance.

11. The hemodynamic simulator of claim 10, in which the clamp is an adjustable thumbwheel clamp.

12. The hemodynamic simulator of claim 11, further comprising a second clamp for each tube used to simulate peripheral resistance.

13. A hemodynamic simulator comprising:
A reservoir for holding fluid;
A manual pump to simulate the right atrium of the heart;
A valve to simulate the tricuspid valve;
A manual pump to simulate the right ventricle of the heart;
A valve to simulate the pulmonary valve;
An elastic container to simulate venous lung capacity;
A manual pump to represent the left atrium of the heart;
A valve to simulate the mitral valve;
A manual pump to represent the right ventricle of the heart;
A valve to simulate the aortic valve;
An elastic container to simulate arterial distensibility;
A pressure gauge to simulate monitoring of blood pressure;
At least two small tubes to simulate peripheral resistance;
A thumbwheel clamp and a second clamp disposed in each said small tube to simulate peripheral resistance;
A surge capacitor to moderate fluid flow;
A flow meter to measure simulated cardiac output;
A small tube to simulate the carotid artery; and
A water wheel placed in the reservoir to simulate brain activity, said water wheel disposed to receive fluid from the simulated carotid artery.
